(19) United States
(12) Patent Application Publication
(10) Pub. No.: US 2007/0203678 A1
(43) Pub. Date: Aug. 30, 2007

(54) Storage medium readable by machine, storing design support program

(75) Inventor: Atsushi Horiike, Yokohama (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/432,122

(22) Filed: May 11, 2006

(30) Foreign Application Priority Data
Feb. 28, 2006 (JP) JP2006-052728

(51) Int. Cl. G06F 17/50

(52) U.S. Cl. 703/1

(57) ABSTRACT

A storage medium readable by a machine, storing a design support program, the program comprising a configuration displaying step of displaying a multidimensional model having a hierarchical structure configured by hierarchically combining parts on the basis of part data that define a multidimensional configuration of part, assembly data that define a part layout or assembly data that specify a layout of other pieces of assembly data, a child model designating step of designating as a processing object, based on input information from a user, a child model corresponding to part of the multidimensional model containing part data or assembly data, and an attribute information displaying step of displaying, by referring to the part data or assembly data corresponding to the child model designated in the child model designating step, an attribute of the child model that contains a position in a hierarchical structure for an image of the multidimensional model.

### BACKGROUND OF THE INVENTION

1. Field of the Invention

The present invention relates to a storage medium readable by a machine, storing a design support program.

2. Description of the Related Art

For example, a design support device such as a CAD (Computer Aided Design) generates images expressing arbitrary two-dimensional or three-dimensional images and data representing these images by combining part data showing a configuration (a shape, a size, etc), assembly data that define a layout of the parts and assembly data showing a layout of other pieces of assembly data. What is called a model is a generic name of the part and the assembly. Herein, there are many cases in which the part data and the assembly data have such a hierarchical structure as to be configured by other part data and other assembly data.

Given is an explanation of a case where a user selects a model from on a [configuration display window] for displaying a configuration of the model in the related art. In this case, a problem is that the user gets hard to recognize a hierarchy of the assembly structure.

FIG. 15 exemplifies a configuration display window 49 and an information tree window 50 in the related art. In the configuration display window 49, the models are displayed as configurations. In the configuration display window 49, the user designates the model by use of a mouse and thus selects the model. In the information tree window 50, the parts configuring the model are displayed in a tree structure corresponding to the hierarchy of the assembly. In the information tree window 50, the user designates the part or the assembly by using the mouse and thus selects the model and the part. Next, a screen in the case of an assembly 51 being selected by the user will be explained with reference to FIG. 16.

In FIG. 16, a part 56 in a configuration display window 54 is depicted by wires (wire frames) and displayed in a color different from the original. This scheme shows that the user has selected the part 56. A status in which the selected part or assembly is depicted by the wires and emphatically displayed (highlighted) in the color different from a pre-selection color is also referred to as a pre-highlight status. Moreover, corresponding to the selection of the part 56, part of an area within the information tree window 55 is colored (in FIG. 16, however, coloring is omitted). Herein, it is shown that a part named Part1 corresponding to the part 56 has been selected by the user.

In terms of utilization, it is assumed that the user deals with several hundreds or several thousands of models and the assemblies that are on the order of ten hierarchies. In the case of the models on such a scale, the assemblies and the parts displayed in the information tree window 50 are a very small proportion of the models to be dealt with. Accordingly, the user needs to scroll the information tree window 50 in order to recognize a model name and an assembly hierarchical structure. In this case, such a problem arises that an entire image of the part and a perspective of the assembly are unclear to the user.

The followings are related arts to the present invention.

[Patent document 1] Japanese Patent Application Laid-Open Publication No. 11-161669

[Patent document 2] Japanese Patent Application Laid-Open Publication No. 2001-282879

### SUMMARY OF THE INVENTION

The present invention of the present application was devised in view of what was required of the related arts. Namely, it is an object of the present invention to provide a technology facilitating a grasp of a hierarchical structure of the assembly together with a configuration.

The present invention adopts the following configurations in order to solve the problems.

(1) Namely, a storage medium readable by a machine, storing a design support program according to the present invention makes a computer execute a configuration displaying step of displaying a multidimensional model having a hierarchical structure configured by hierarchically combining parts on the basis of part data that define a multidimensional configuration of the part, assembly data that define a part layout or the assembly data that specify a layout of other pieces of assembly data, a child model designating step of designating as a processing object, based on input information from a user, a child model corresponding to part of the multidimensional model containing the part data or the assembly data, and an attribute information displaying step of displaying, by referring to the part data or assembly data corresponding to the child model designated in the child mode designating step, an attribute of the child model that contains a position in a hierarchical structure thereof with respect to an image of the multidimensional model.

According to this construction, a program in this storage medium makes the computer display the multidimensional model having the hierarchical structure configured by hierarchically combining the parts on the basis of the part data that define the multidimensional configuration of the part, the assembly data that define the part layout or the assembly data that specify the layout of other pieces of assembly data. Further, this program makes the computer designate as the processing object, based on the input information from the user, the child model corresponding to part of the multidimensional model containing the part data or the assembly data. This program makes the computer display, by referring to the part data or assembly data corresponding to the designated child model, the attribute of the child model that contains the position in the hierarchical structure thereof with respect to the image of the multidimensional model.

(2) Moreover, the design support program in this storage medium according to the present invention may make the computer determine a degree of depth of the hierarchy with respect to the hierarchical structure.

(3) Further, the design support program in this storage medium according to the present invention may make the computer display the determined degree of depth of the hierarchy.

(4) Still further, the design support program in this storage medium according to the present invention may make the computer execute edit the part data or the assembly data in response to the input information from the user.

(5) Yet further, the design support program in this storage medium according to the present invention may make the computer display, together with the degree of depth of the hierarchy, a child model name defined as an identification name assigned to the part data or the assembly data.

The present invention may also be a design support device making the computer execute the processes described above.

According to the present invention, it is possible to provide the technology facilitating the grasp of the hierarchical structure of the assembly together with the configuration.

### BRIEF DESCRIPTION OF THE DRAWINGS

FIG. 1 is a diagram showing a basic architecture of a design support device in an embodiment of the present invention;

FIG. 2 is a diagram showing a function block diagram of a model data management module according to the embodiment of the present invention;

FIG. 3 is a diagram showing a first example of a configuration display window and an information tree window according to the embodiment of the present invention;

FIG. 4 is a diagram showing a structure of assembly data according to the embodiment of the present invention;

FIG. 5 is a diagram showing a structure of part data according to the embodiment of the present invention;

FIG. 6 is a diagram showing a parent-to-child relationship between the assembly and the part according to the embodiment of the present invention;

FIG. 7 is a flowchart showing a hierarchy generating process in the embodiment of the present invention;

FIG. 8 is a flowchart showing a hierarchy moving process in the embodiment of the present invention;

FIG. 9 is a tool chip display table explaining display information according to the embodiment of the present invention;

FIG. 10 is a diagram showing an operation auxiliary window according to the embodiment of the present invention;

FIG. 11 is a diagram showing a second example of the configuration display window and the information tree window according to the embodiment of the present invention;

FIG. 12 is a diagram showing a third example of the configuration display window and the information tree window according to the embodiment of the present invention;

FIG. 13 is a diagram showing a fourth example of the configuration display window and the information tree window according to the embodiment of the present invention;

FIG. 14 is a diagram showing a fifth example of the configuration display window and the information tree window according to the embodiment of the present invention;

FIG. 15 is a diagram showing a first example of the configuration display window and the information tree window according to the related art; and

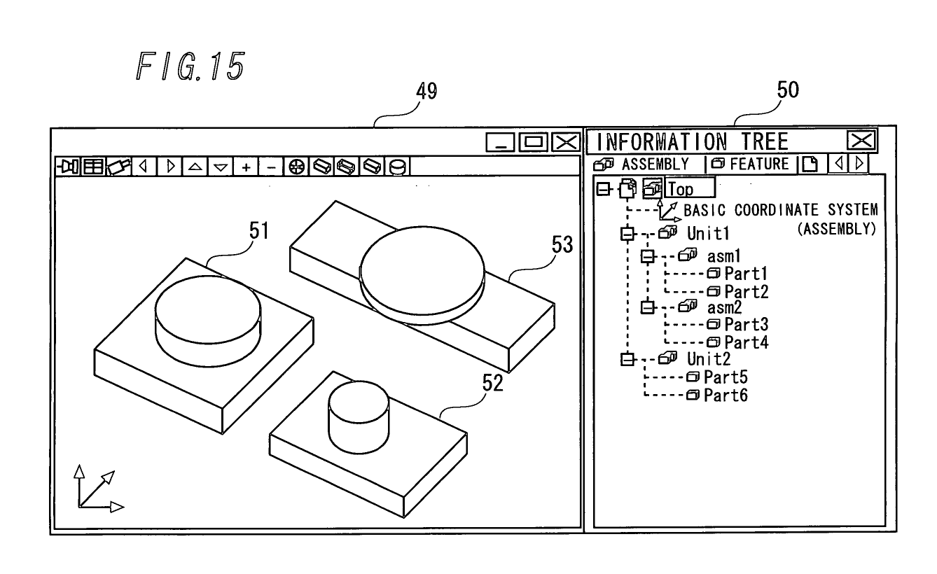

FIG. 16 is a diagram showing a second example of the configuration display window and the information tree window according to the related art.

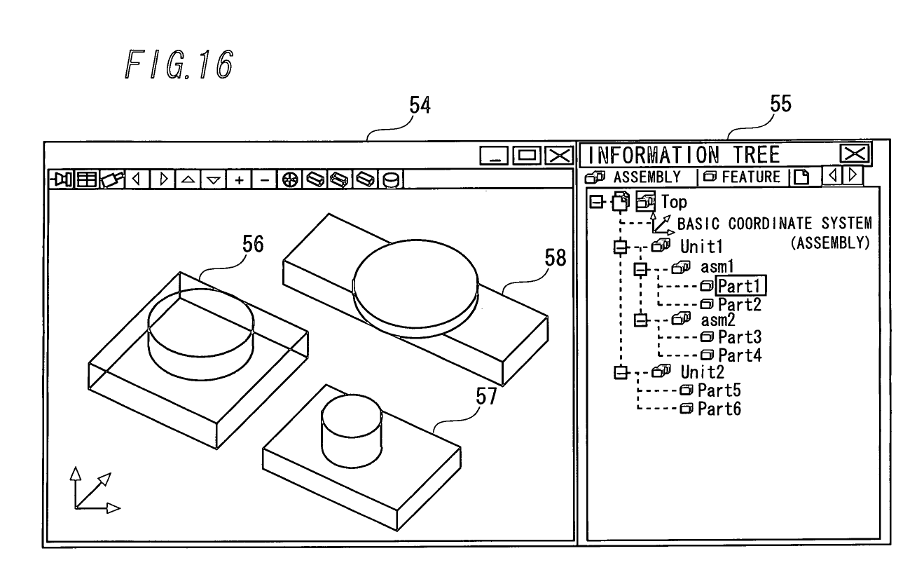

### DETAILED DESCRIPTION OF THE PREFERRED EMBODIMENT

A design support device according to an embodiment of the present invention will hereinafter be described with reference to the drawings. A configuration in the following embodiment is an exemplification, and the present invention is not limited to the configuration in the embodiment.

<<System Architecture>>

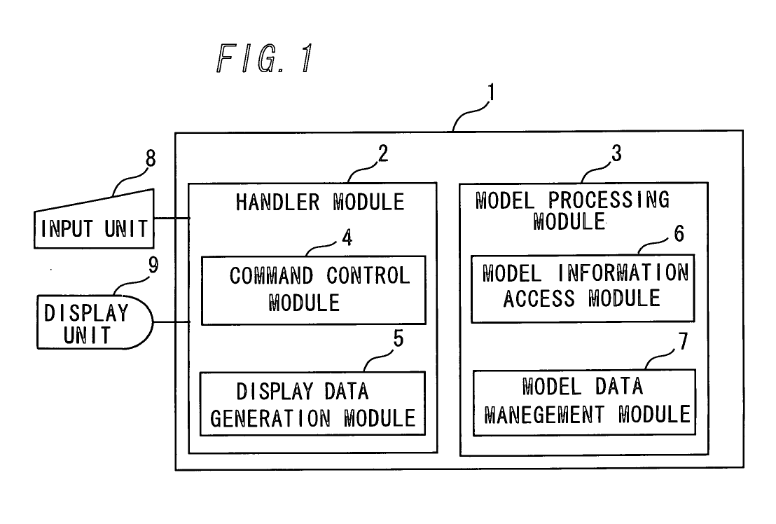

FIG. 1 is a diagram of a system structure of a design support device 1. The design support device 1 includes a handler module 2 and a model processing module 3. The handler module 2 has a command control module 4 and a display data generation module 5. The model processing module 3 has a model information access module 6 and a model data management module 7. An input unit 8 and a display unit 9 are connected to the design support device 1. The design support device 1 includes a hard disc, a memory, a central processing unit (CPU) and an interface used for inputting and outputting information to and from other devices. The hard disc provided in the design support device 1 is installed with a program by which the design support device 1 is made to execute processes in the embodiment. The CPU provided in the design support device 1 executes the processes in the embodiment upon execution of the program installed into the hard disc provided in the design support device 1.

Input information is inputted to the design support device 1 from the input unit 8. The design support device 1 processes input information from the input unit 8 by executing the program installed into the hard disc provided in the design support device 1, and outputs a processing result to the display unit 9.

The handler module 2 controls an input of the information from the input unit 8. The handler module 2 controls an output of output information to the display unit 9. The command control module 4 provided in the handler module 2 receives an input of input information (command) from the input unit 8. The command control module 4 outputs, to the model processing module 3, information that specifies a part or an assembly etc corresponding to the inputted command. The display data generation module 5 provided in the handler module 2 receives an input of output information from the model processing module 3. The display data generation module 5 converts the inputted output information into data to be outputted to the display unit 9, and outputs the converted data to the display unit 9.

The model processing module 3 processes the information given from the handler module 2, and outputs a processing result to the handler module 2. The model information access module 6 provided in the model processing module 3 receives an input of information that specifies the part or the assembly etc from the command control module 4. The model information access module 6 outputs the inputted information to the model data management module 7. The model data management module 7 provided in the model processing module 3 processes the information inputted from the model information access module 6, and executes generating a model configuration, and so on. The model data management module 7 outputs the processed information to the display data generation module 5. The input unit 8 includes input devices such as a keyboard and a mouse. The display unit 9 includes a display device such as a display. Further, the display unit 9 may include a printer.

An operation of the design support device 1 will be explained with reference to FIG. 1. To begin with, a user switches ON power sources of the design support device 1 and of the display unit 9. Next, the user operates the input unit 8, thereby inputting the information to the command control module 4. The command control module 4, upon the input of the input information (command) from the input unit 8, outputs to the model information access module 6 the information that specifies the part or the assembly etc in accordance with the inputted information. The model information access module 6, when the information is inputted from the command control module 4, outputs the inputted information to the model data management module 7. The model data management module 7 executes the process corresponding to the information given from the input unit 8. For example, the model data management module 7 generates a model configuration in response to the inputted command. The model data management module 7 outputs a result of the executed process to the display data generation module 5. The display data generation module 5 converts the inputted processing result into data to be outputted to the display unit 9, and outputs the converted data to the display unit 9. The display unit 9 displays the data given from the display data generation module 5. Thus, upon inputting the information (command) from the input unit 8, the design support device 1 executes generating the model configuration by the process corresponding to the inputted information, and outputs the result of the processing to the display unit 9. This display unit 9 displays, to the user, the result of the processing by the design support device 1.

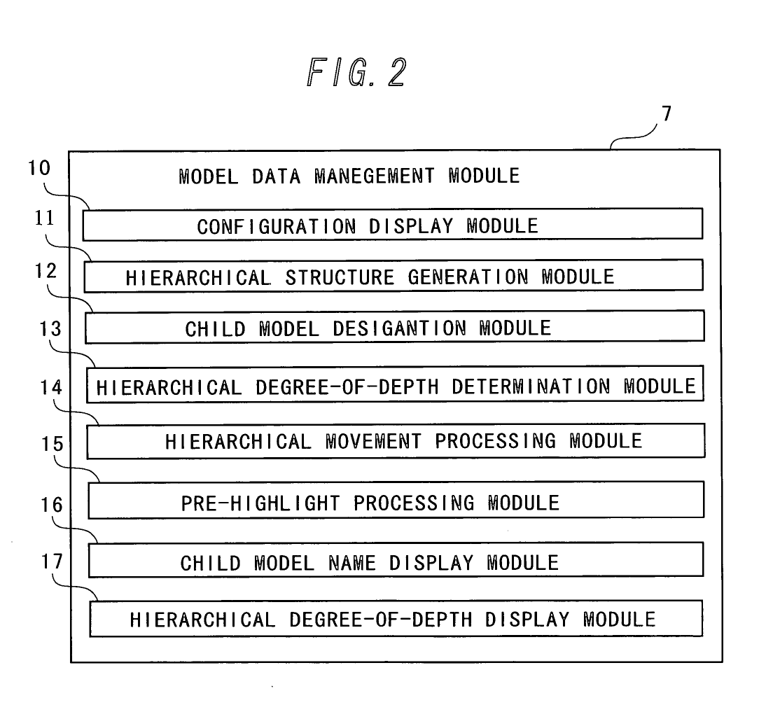

FIG. 2 shows function blocks included in the model data management module 7. The model data management module 7 includes a configuration display module 10, a hierarchical structure generation module 11, a child model designation module 12, a hierarchical degree-of-depth determination module 13, a hierarchical movement processing module 14, a pre-highlight processing module 15, a child name display module 16 and a hierarchical degree-of-depth display module 17.

The configuration display module 10 displays a model generated by combining the parts and the assemblies. The hierarchical structure generation module 11 generates a hierarchical structure of the assembly. In response to the input information from the input unit 8, the child model designation module 12, when the model is designated by the user's operation on the input unit 8, designates, as a processing object, a child model (which is a generic name including the part and the assembly and is one of them). The hierarchical degree-of-depth determination module 13 determines a degree of depth of the hierarchical structure of the assembly. The hierarchical movement processing module 14 executes a process of moving the processing object in the hierarchical structure of the assembly. The pre-highlight processing module 15 displays the part or the assembly in a pre-highlight status. The child model name display module 16 displays a child model name in a configuration display window. Further, the child model name display module 16 may also display the child model name in an information display window. The hierarchical degree-of-depth display module 17 displays the degree-of-depth in the configuration display window. Moreover, the hierarchical degree-of-depth display module 17 may also display the hierarchical degree-of-depth in an information tree window.

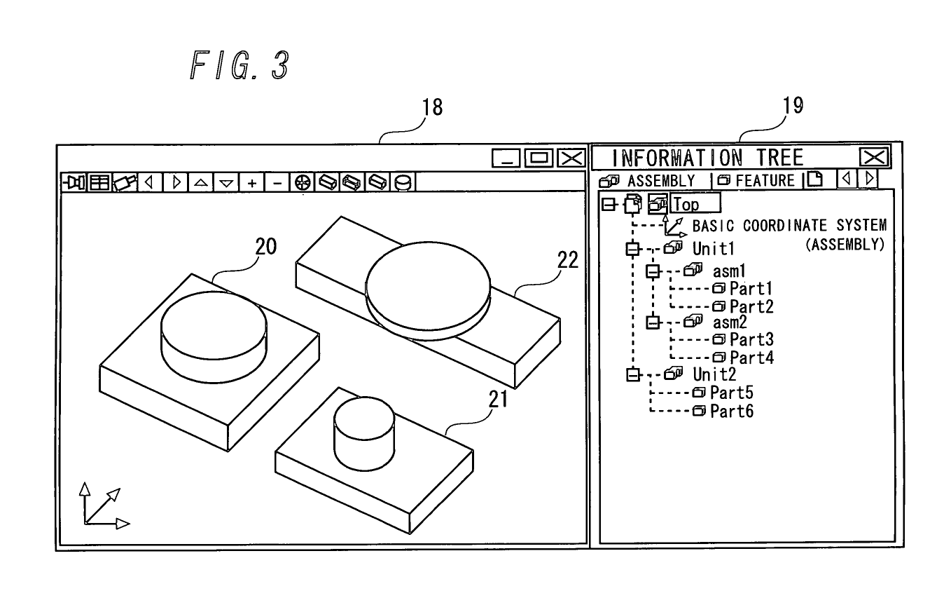

FIG. 3 illustrates a configuration display window 18 and an information tree window 19 before executing the hierarchical movement process in the hierarchical structure of the assembly. In the configuration display window 18, the model is displayed as a configuration. In FIG. 3, in the configuration display window 18, assemblies 20 through 22 are displayed. The assembly 20, in the configuration window 18, contains assemblies and parts of a hierarchy under the assembly 20 (an assembly name: asm1) in the information tree window 19. Herein, the part is configured by faces and edges. Further, the assembly represents a layout of the parts and a layout of other assemblies. The assembly 21, in the configuration window 18, contains the assemblies and the parts of a hierarchy under an assembly asm2 (corresponding to the assembly 21) in the information tree window 19. The assembly 22, in the configuration window 18, contains the assemblies and the parts of a hierarchy under an assembly Unit2 (corresponding to the assembly 22) in the information tree window 19. The assembly Unit1 displayed in the information tree window 19 contains the assembly asm1 (the assembly 20) and the assembly asm2 (the assembly 21). An assembly Top displayed in the information tree window 19 contains the assembly Unit1 and the assembly Unit2.

<<Data Structure>>

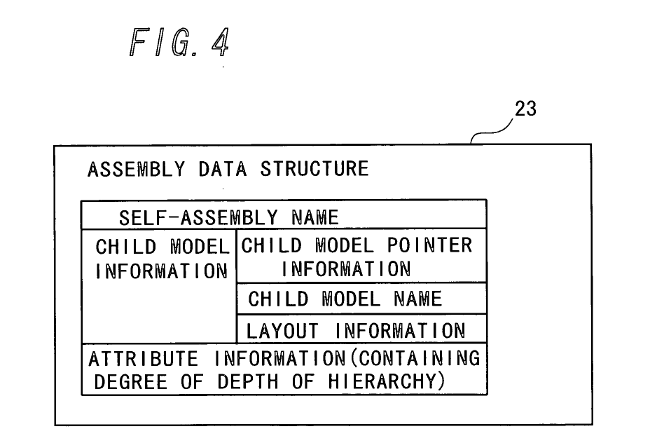

A structure of the data used in the embodiment of the present invention will hereinafter be described with reference to FIGS. 4-6. FIG. 4 shows an assembly data structure 23. The assembly data structure 23 contains a self-assembly name, child model information and attribute information. The child model information contains child model pointer information, a child model name and layout information. The child model pointer information is defined as information for designating other assemblies or parts. There may be a plurality of other assemblies or parts designated by the child model pointer information. The layout information is information that designates a layout of the other assemblies or parts designated by the child model pointer information. There may be a plurality of designations of other assemblies or parts included in the layout information. The attribute information contains information about the degree of depth of the hierarchy in the hierarchical structure of the assembly.

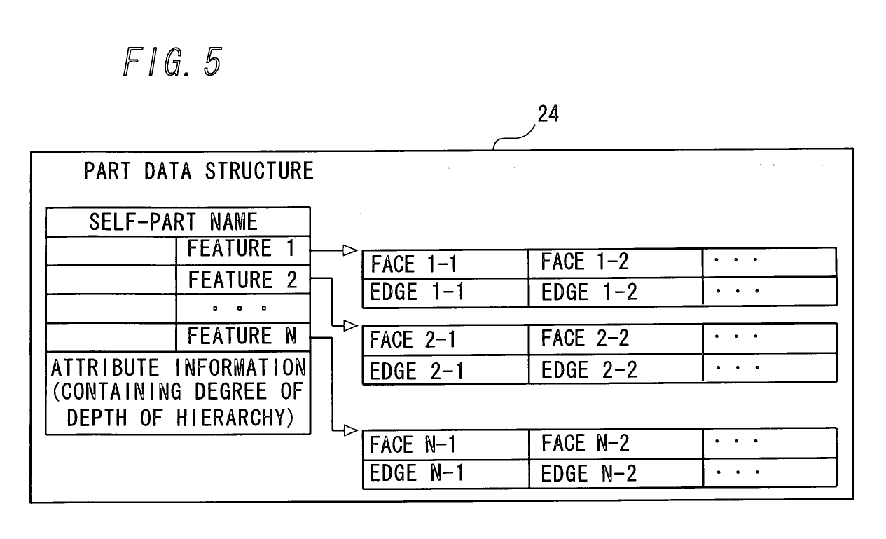

FIG. 5 shows a part data structure 24. The part data structure 24 contains a self-part name, feature information, attribute information, etc. The feature information contains pieces of information on the faces and the edges, and is information defining configurations such as protrusions, holes, etc. The configuration of the part is generated by combining plural pieces of feature information. The attribute information contains information on the degree of depth of the hierarchy in the hierarchical structure of the assembly.

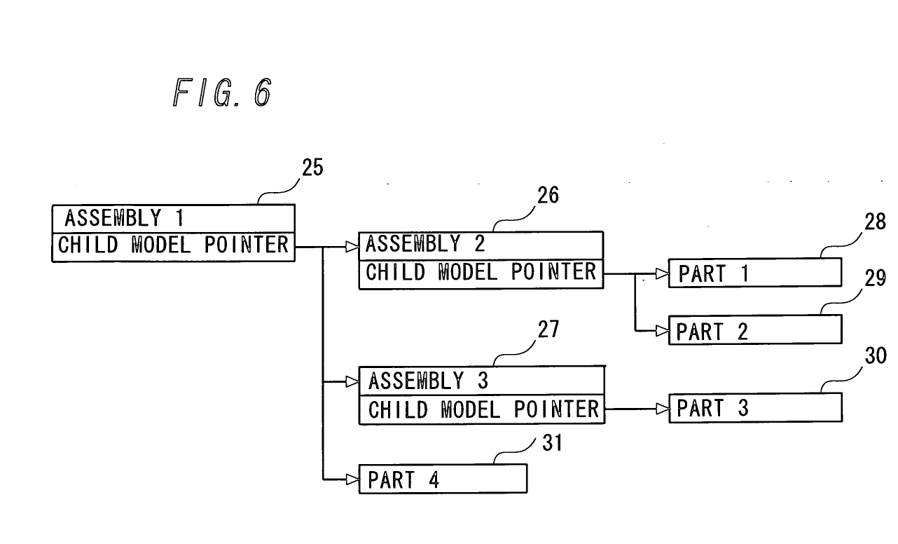

FIG. 6 shows a relationship (parent-to-child relationship) between the assembly and the part through the pointer. The numerals 25-27 correspond to the [assembly 1] through the [assembly 3], respectively. The numerals 28-31 correspond to the [part 1] through the [part 4], respectively. The parent-to-child relationship is a relationship, wherein the designator data by the pointer is defined as a parent, while the designated data by the pointer is defined as a child. For example, in the relationship between the [assembly 1] and the [assembly 2], the [assembly 1] is the parent, while the [assembly 2] is the child. Each of the [assembly 1] through the [assembly 3] includes the assembly data structure 23 (see FIG. 4). Each of the [part 1] through the [part 4] includes a part data structure 24 (see FIG. 5).

Information of a child model pointer of the [assembly 1] contains pieces of information for designating the [assembly 2], the [assembly 3] and the [part 4] from the [assembly 1]. Based on this structure, the model data management module 7 can designate respectively the [assembly 2], the [assembly 3] and the [part 4] from the information of the child model pointer of the [assembly 1]. Further, the model data management module 7 manages the information of the pointer in a reversed direction of this pointer information, whereby the [assembly 1] can be designated from the [assembly 2], the [assembly 3] or the [part 4].

Information of a child model pointer of the [assembly 2] contains pieces of information for designating the [part 1] and the [part 2] from the [assembly 2]. Based on this structure, the model data management module 7 can designate respectively the [part 1] and the [part 2] from the information of the child model pointer of the [assembly 2]. Moreover, the model data management module 7 manages the information of the pointer in a reversed direction of this pointer information, whereby the [assembly 2] can be designated from the [part 1] or the [part 2].

Information of a child model pointer of the [assembly 3] contains information for designating the [part 3] from the [assembly 3]. Based on this structure, the model data management module 7 manages the information of the pointer in a reversed direction of this pointer information, whereby the [part 3] can be designated from the child model pointer information of the [assembly 3]. Further, the model data management module 7 manages the information of the pointer in a reversed direction of this pointer information, whereby the [assembly 3] can be designated from the [part 3].

The hierarchical structure generation module 11 generates data that defines the hierarchical structure. For instance, such a case will be explained that the hierarchical structure generation module 11 generates the [assembly 1] as an assembly including the [assembly 2], the [assembly 3] and the [part 4]. In this case, the hierarchical structure generation module 11 generates the child model pointer information (the information used for designating the [assembly 2], the [assembly 3] and the [part 4]) of the [assembly 1] the information that designates a name of the child model designated by the child model pointer information, and layout information that designates a layout of the respective child models.

The assembly data structure 23 (see FIG. 4) and the part data structure 24 (see FIG. 5) contain the degree of depth of hierarchy as the attribute information. The hierarchical degree-of-depth determination module 13 (see FIG. 2) provided in the model data management module 7 updates the degree of depth of hierarchy after adding the assembly or the part etc. The hierarchical degree-of-depth determination module 13 executes updating as follows.

A process of how the hierarchical degree-of-depth determination module 13 updates the degree of depth of hierarchy will be explained with reference to FIG. 6. To begin with, the hierarchical degree-of-depth determination module 13 sets, to “0”, a degree of depth of the hierarchy of the assembly data structure 23 (see FIG. 4) of the [assembly 1]. Next, the hierarchical degree-of-depth determination module 13 reads the information that designates the assemblies or the parts of the child of the [assembly 1] from the child model pointer information of the assembly data structure 23 of the [assembly 1]. The hierarchical degree-of-depth determination module 13 calculates, along with the readout information, an assembly count A(1) of the readout assemblies. The hierarchical degree-of-depth determination module 13 reads the [assembly 2], the [assembly 3] and the [part 4] as the information that designates the child assemblies or child parts of the [assembly 1] from the child model pointer information of the assembly data structure 23 of the [assembly 1]. Further, the hierarchical degree-of-depth determination module 13 makes a calculation such as A(1)=2. The symbol A(1) shows the assemblies read from the child model pointer information of the [assembly 1], and represents the assembly count of the not-yet-processed assemblies. The hierarchical degree-of-depth determination module 13 gets a bit flag etc contained in a field of the attribute information of the [assembly 1] in order to show that the [assembly 1] has already been processed. The hierarchical degree-of-depth determination module 13 sets the degree of depth of the hierarchy of the part on the basis of the child model pointer information and the degree of depth of the hierarchy of the [assembly 1]. The degree of depth of the hierarchy of the assembly 23 is “0”, and hence the hierarchical degree-of-depth determination module 13 sets, to “1”, the degree of depth of the hierarchy of the [part 4] by adding “1” to “0”. The hierarchical degree-of-depth determination module 13 gets the bit flag etc contained in a field of the attribute information of the [part 4], which flag shows that the [part 4] has already been processed.

The hierarchical degree-of-depth determination module 13 moves the processing object to the [assembly 2]. On this occasion, the hierarchical degree-of-depth determination module 13 decrements by “1” the assembly count A(1) calculated in the process about the [assembly 1], resulting in A(1)=1. The hierarchical degree-of-depth determination module 13, in the same way as the process about the [assembly 1], sets the degree of depth of the hierarchy of the [assembly 2] to “1”, and sets the degree of depth of the hierarchy of each of the [part 1] and the [part 2] to “2”. The hierarchical degree-of-depth determination module 13 makes a calculation of A(2)=0 as an assembly count A(2) read from the child model pointer information of the [assembly 2]. The hierarchical degree-of-depth determination module 13 moves the processing object to the [assembly 3] from the [assembly 2]. On this occasion, the hierarchical degree-of-depth determination module 13, as a process about the [assembly 1], decrements the readout assembly count A81) by “1”, resulting in A(1)=0. The hierarchical degree-of-depth determination module 13, in the same way as the process about the [assembly 1], sets the degree of depth of the hierarchy of the [assembly 3] to “1”, and sets the degree of depth of hierarchy of the [part 3] to “2”. The hierarchical degree-of-depth determination module 13 makes a calculation of A(3)=0 as an assembly count A(3) read from the child model pointer information of the [assembly 3].

Thus, the hierarchical degree-of-depth determination module 13 provided in the model data management module 7 calculates at “0” the degree of depth of the hierarchy of the [assembly 1], calculates at “1” each of the degrees of depths of the hierarchies of the [part 1] through the [part 3], and calculates at “1” the degree of depth of the hierarchy of the [part 4].

### WORKING EXAMPLE

### First Operational Example

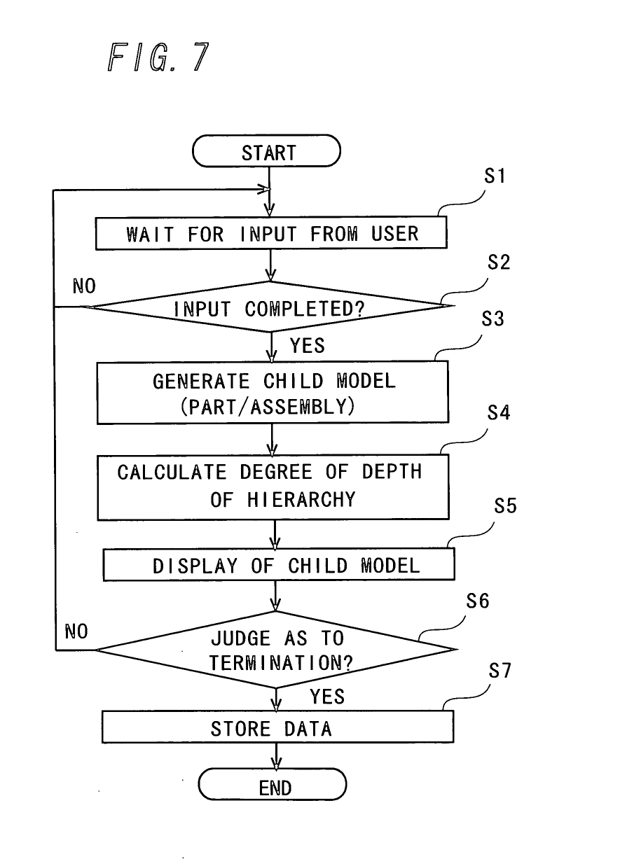

A first operational example of the model data management module 7 of the design support device 1 according to the embodiment, will hereinafter be described with reference to FIG. 7. In this operation, the hierarchical structure generation module 11 (see FIG. 2) provided in the model data management module 7 generates a model corresponding to the information inputted by the user from the input unit 8. The hierarchical degree-of-depth determination module 13 provided in the model data management module 7 calculates the degree of depth of the hierarchy of the thus-generated model. The configuration display module 10 provided in the model data management module 7 displays the generated model.

At first, the hierarchical structure generation module 11 provided in the model data management module 7 waits for a user's input from the input unit 8 (S1). The model data management module 7, in a status of waiting for the input of the information from the input unit 8, proceeds with the processing to step S2.

A process in step S2 is that the hierarchical structure generation module 11 provided in the model data management module 7 judges whether or not the information is inputted from the user (S2). The hierarchical structure generation module 11, when judging that the user's input of the information from the input unit 8 is not completed (S2; NO), proceeds with the processing step S1. The hierarchical structure generation module 11, when judging that the user's input of the information from the input unit 8 is completed (S2; YES), proceeds with the processing to step S3.

In the process in step S3, the hierarchical structure generation module 11 generates the model corresponding to the information inputted by the user in the process in step S1. The hierarchical structure generation module 11, on the occasion of generating the model, updates each piece of child model information contained in the assembly data structure 23 (see FIG. 4) in accordance with the parts etc combined in the model. The hierarchical structure generation module 11, after the process in step S3, proceeds with the processing to step S4.

In the process in step S4, the hierarchical degree-of-depth determination module 13 provided in the model data management module 7 calculates a degree of depth of the hierarchy of the whole model with respect to the model that has been addition-updated in the process in step S3 (S4). The hierarchical degree-of-depth determination module 13, when calculating the degree of depth, registers the calculated degree of depth in the memory provided in the model data management module 7. The hierarchical degree-of-depth determination module 13, after registering the calculated degree of depth in the memory, proceeds with the processing to step S5.

In the process in step S5, the configuration display module 7 provided in the model data management module 7 displays, in the configuration display window, the model generated in the process in step S3 (S5). After the process in step S5, the model data management module 7 proceeds with the processing to step S6.

In the process in step S6, the model data management module 7 judges whether or not information terminating the generation of the hierarchical structure is inputted from the user (S6). The model data management module 7, when judging that the information terminating the generation of the hierarchical structure is inputted from the user (S6; YES), proceeds with the processing to step S7. The model data management module 7, when judging that the information terminating the generation of the hierarchical structure is not inputted from the user (S6; NO), loops back to the process in step S1.

In the process in step S7, the model data management module 7 stores the data representing the model generated in the process in step S3 in the hard disc provided in the design support device 1 (S7). After the process in step S7, the model data management module 7 finishes the hierarchical structure generation process.

### Second Operational Example

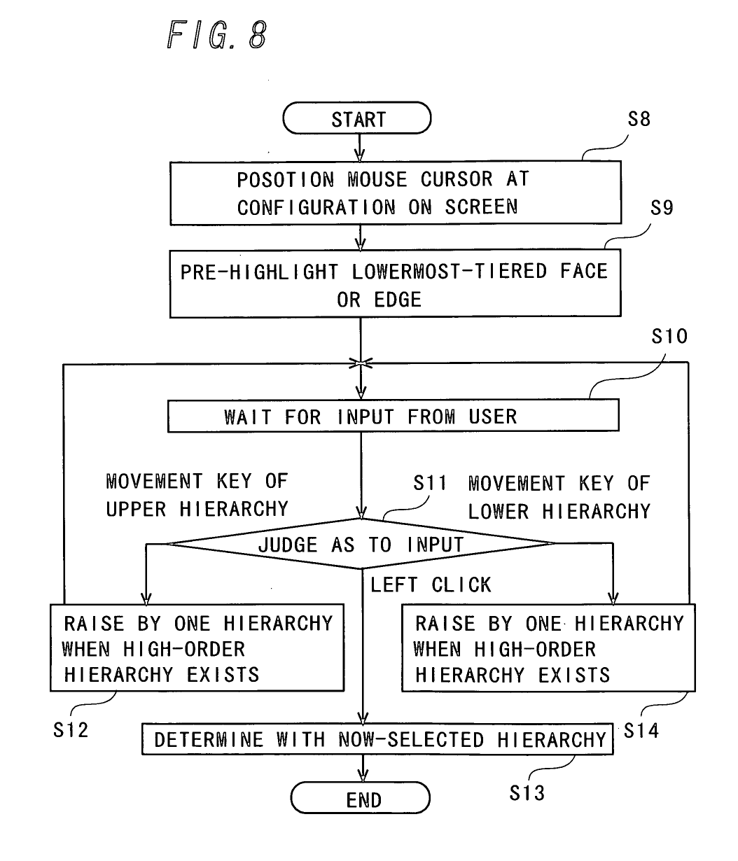

A second operational example of the model data management module 7 of the design support device 1 according to the embodiment, will hereinafter be explained with reference to FIG. 8. In this operation, the model data management module 7, corresponding to the information inputted by the user's operation trough the input unit 8, executes the process of moving the hierarchy in the hierarchical structure of the assembly, and displays an executed result on the display unit 9.

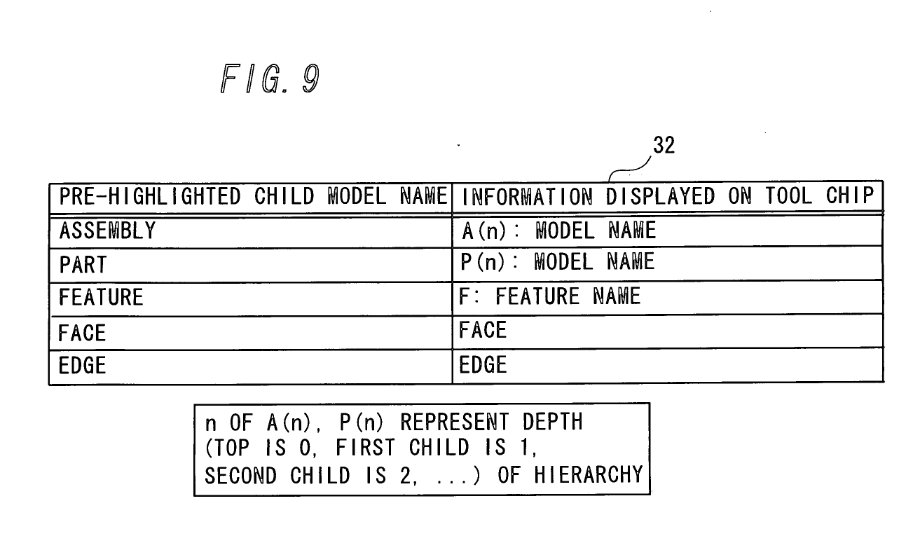

To start with, the information displayed in the configuration display window by the model data management module 7 will be explained. FIG. 9 shows a tool chip display table 32 in which items of information displayed in the configuration display window are categorized and thus enumerated. These items of information are displayed to the user via the display unit 9. In the tool chip display table 32 shown in FIG. 9, the child names are displayed in a left-sided column of the tool chip display table 32. Further, when the models described in the left-sided column of the tool chip display table 32 are displayed by pre-highlighting, items of information that should be displayed in the vicinities of the pre-highlighted models are described in the right-sided column of the tool chip display table 32. For instance, [A(n):model name] is displayed as (associated with) the [assembly] in the tool chip display table 32. Herein, n is the degree of depth of the hierarchy. The hierarchical degree-of-depth n is displayed in such a way that a first child is “1”, a second child is “2”, and so on. Further, [P(n): model name] is displayed on the display unit 9 as (associated with) the [part] in the tool chip display table 32. Thus, the tool chip display table 32 represents an associated relationship between the child mode name and the information thereof. The information described in the right-sided column of the tool chip display table 32, i.e., the information displayed in the tool chip, is displayed to the user via the display unit 9.

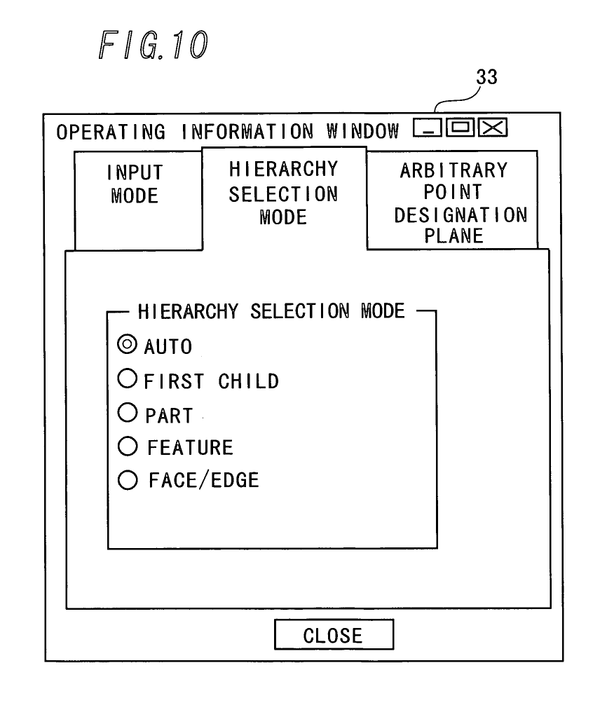

Next, an operation auxiliary window 33 shown in FIG. 10 will be explained. Displayed in the operation auxiliary window 33 are [auto], [first child], [part], [feature] and [face/edge] as hierarchy selection modes. The user can select one of these selection modes via the input unit 8. When the hierarchy selection mode is selected by the user, the model data management module 7 sets the selected operation mode in the design support device 1.

For example, when the [auto] is selected in the auxiliary window 32 by an operation through the input unit 8, the child model designation module 12 (see FIG. 2) provided in the model data management module 7 designates, on the occasion of the model's being selected in the configuration display window 8 (see FIG. 3), one of the elements of the lowermost hierarchy in the hierarchies as a processing object child mode, which elements are selectable by an execution command.

Further, when [first child] is selected in the auxiliary window 32 through the input unit 8, the child model designation module 12 registers a piece of information for instructing a search for the [first child] in the memory provided in the design support device 1. The child model designation module 12, on the occasion of the model's being selected in the configuration display window 18, designates the hierarchy of the first child as the processing object child model.

Further, when the [part] is selected in the auxiliary window 32 through the input unit 8, the child model designation module 12 registers a piece of information for instructing the search for the [part] in the memory provided in the design support device 1. The child model designation module 12, if the part can be searched for by the execution command on the occasion of the model's being selected in the configuration display window 18, designates the part of the lowermost hierarchy among the searchable parts as the processing object child model.

Moreover, when the [feature] is selected in the auxiliary window 32 through the input unit 8, the child model designation module 12 registers a piece of information for instructing the search for the [feature] in the memory provided in the design support device 1. The child model designation module 12, if the feature can be searched for by the execution command on the occasion of the model's being selected in the configuration display window 18, designates the feature of the lowermost hierarchy among the searchable features as the processing object.

Further, when the [face/edge] is selected in the auxiliary window 32 through the input unit 8, the child model designation module 12 registers a piece of information for instructing the search for the [face/edge] in the memory provided in the design support device 1. The child model designation module 12, if the face or the edge can be searched for by the execution command on the occasion of the model's being selected in the configuration display window 18, designates the face or the edge of the lowermost hierarchy among the searchable faces or edges as the processing object child model. Herein, based on the assumption that the [part] is selected in the auxiliary window 32, a process executed by the model data management module 7 will be explained.

To begin with, corresponding to the input from the input unit 8, the model data management module 7 positions a mouse cursor at the configuration, which is displayed on the configuration display window 18 (see FIG. 3), and selects the part or the assembly (S8). Herein, there will hereinafter be given the process in a case where the assembly 20 (see FIG. 3) is selected by an operation upon the input unit 8.

In the process in step S9, the pre-highlight processing module 15 provided in the model data management module 7 pre-highlights the face or the edge of the lowermost hierarchy of the configuration positioned through the process in step S1 (S9). The model data management module 7 proceeds with the processing to step S10 after the process in step S9.

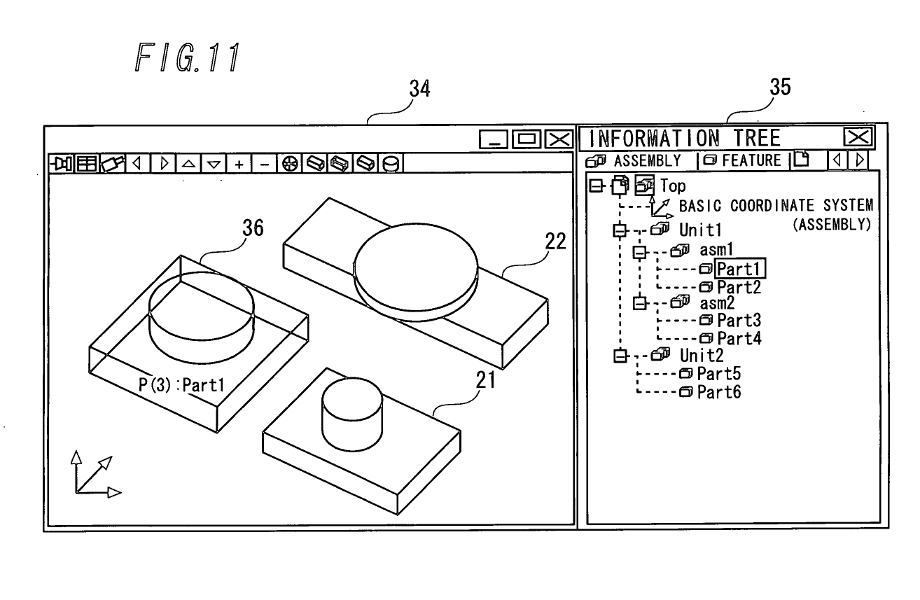

FIG. 11 exemplifies a configuration display window 34 in the case of the model's being selected in the process in step S1. The pre-highlight processing module 15 (see FIG. 2) provided in the model data management module 7 displays a part 36 in a way that pre-highlights this part 36 the configuration display window 34, which is selected by the child model designation module 12. The child model name display module 16 provided in the model data management module 7 displays a name of the child model selected by the child model designation module 12 under the part 36 within the configuration display window 34. Furthermore, the hierarchical degree-of-depth display module 17 provided in the model data management module 7 displays a degree of depth of the hierarchy of the child model selected by the child model designation module 12 under the part 36 within the configuration display window 34. In P(3): Part1 shown in FIG. 11, “P” represents apart, “3” designates a degree of depth of the hierarchy, and Part1 stands for a part name (child model name). Further, the model data management module 7 may display only the name of the selected child model or only the degree of depth of the hierarchy of the selected child model. The user can recognize from this display the degree of depth of the hierarchy. In the example shown in FIG. 11, the user can recognize that part name is Part1, and the degree of depth of the hierarchy is “3”.

In the process in step S10, the hierarchical movement processing module 14 provided in the model data management module 7 waits for an input from the handler module 2 till an upper hierarchical movement key or a lower hierarchical movement key is pressed or a left click is done (S10). The hierarchical movement processing module 14, when there is given an input of the upper hierarchical movement key, the lower hierarchical movement key or the left click, proceeds with the processing to step S11.

In the process in step S11, the hierarchical movement processing module 14 judges as to the input given in the process in step S11. The hierarchical movement processing module 14, when judging that the upper hierarchical movement key (e.g., F11 key) is pressed, proceeds with the processing to S12. The hierarchical movement processing module 14, when judging that the lower hierarchical movement key (e.g., F12 key) is pressed, proceeds with the processing to S13. The hierarchical movement processing module 14, when judging that the hierarchy determination key (e.g., the left click) is pressed, proceeds with the processing to S14.

In the process in step S12, the hierarchical movement processing module 14 judges whether or not there is a high-order hierarchy above the hierarchy of the structure of the selected assembly. The hierarchical movement processing module 14, when judging that there exists the high-order hierarchy, moves up by one the hierarchy of the structure of the selected assembly. The hierarchical movement processing module 14, after moving the hierarchy, proceeds with the processing to S10.

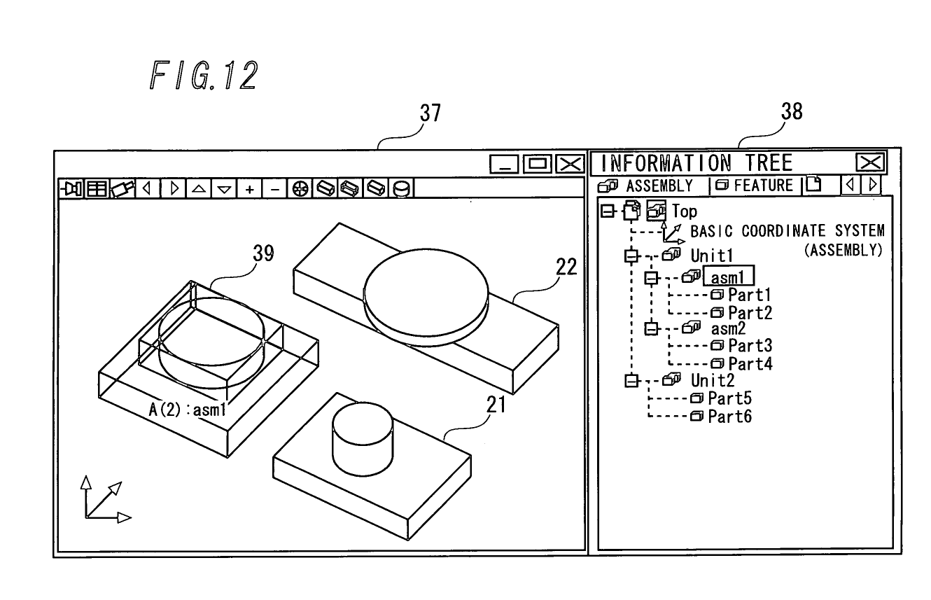

FIG. 12 shows a screen displayed when the upper hierarchical movement key is pressed once from the screen status shown in FIG. 11. FIG. 12 exemplifies a configuration display window 37 and an information tree window 38. In FIG. 12, an assembly 39 is set in the pre-highlighted status. In A(2): asm1 shown in FIG. 12, “A” represents an assembly, “2” designates a degree of depth of the hierarchy, and “asm1” denotes an assembly name (child model name).

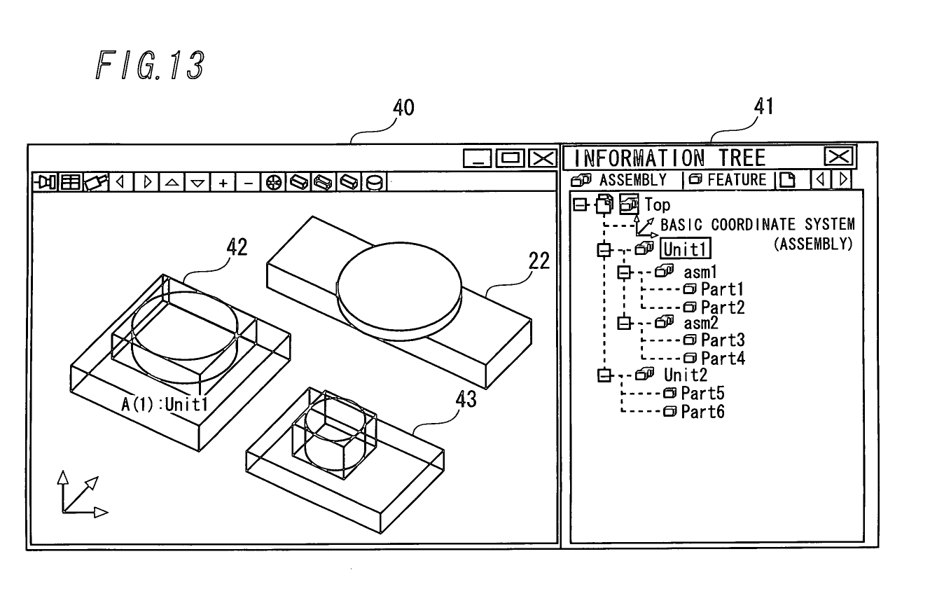

FIG. 13 shows a screen displayed when the upper hierarchical movement key is pressed twice from the screen status shown in FIG. 11. FIG. 13 exemplifies a configuration display window 40 and an information tree window 41. In FIG. 13, an assembly 42 is set in the pre-highlighted status. In A(1): Unit1 shown in FIG. 13, “A” represents an assembly, “1” designates a degree of depth of the hierarchy, and “Unit1” denotes an assembly name (child model name).

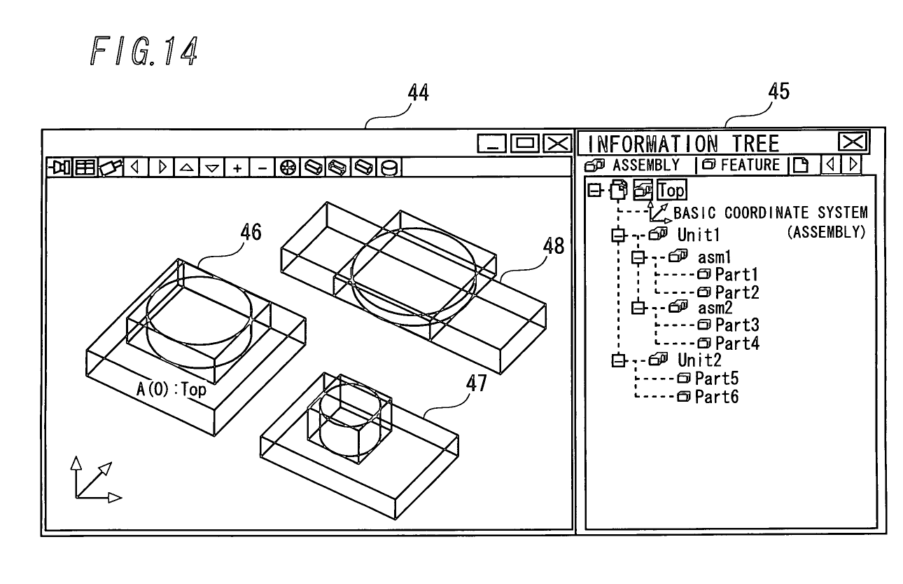

FIG. 14 shows a screen displayed when the upper hierarchical movement key is pressed three times from the screen status shown in FIG. 11. FIG. 14 exemplifies a configuration display window 44 and an information tree window 45. In FIG. 14, an assembly 46 is set in the pre-highlighted status. In A(0): Top shown in FIG. 14, “A” represents an assembly, “0” designates a degree of depth of the hierarchy, and “Top” denotes an assembly name (child model name).

In the process in step S13, the hierarchical movement processing module 14 provided in the model data management module 7 judges whether or not there exists a low-order hierarchy under the hierarchy of the structure of the selected assembly. The hierarchical movement processing module 14, when judging that the low-order hierarchy exists, moves down by one the hierarchy of the structure of the selected assembly. The hierarchical movement processing module 14, after moving the hierarchy, proceeds with the processing to S10.

For example, FIG. 13 illustrates the screen displayed in the case where the lower hierarchical movement key is pressed once from the screen status shown in FIG. 14. FIG. 12 shows a screen displayed when the lower hierarchical movement key is pressed twice from the screen status shown in FIG. 14. FIG. 10 shows a screen displayed when the lower hierarchical movement key is pressed three times from the screen status shown in FIG. 14.

In a process in step S14, the model data management module 7 determines with a now-selected hierarchy (S14). After an end of step S14, the model data management module 7 finishes the process of moving the hierarchy of the structure of the assembly.

In the way described above, the design support device 1 displays the multidimensional model configured by hierarchically combining the parts on the basis of the part data that define the multidimensional configuration of the part, the assembly data that define the part layout or the assembly data that specify the layout of other pieces of assembly data. The design support device 1 designates as the processing object, based on the input information from the user, the child model corresponding to part of the multidimensional model in accordance with any one item of part data or assembly data. Then, the design support device 1 is capable of, by referring to the part data or assembly data corresponding to the thus-designated child model, displaying as the attribute of the child model the position containing the degree of depth of the hierarchy in the hierarchical structure of the processing object child model with respect to the image of the multidimensional model.

### MODIFIED EXAMPLE

The design support device 1 described in the embodiment determines the degree of depth of the hierarchy when generating the model. The design support device 1 may, however, also be a device that calculates the degree of depth of the hierarchy when displaying the model and displays the degree of depth of the hierarchy and the child model name. In the case of this modified example, for example, in the processes in steps S9, S12 and S13 shown in FIG. 8, the hierarchical degree-of-depth determination module 13 calculates the degree of depth of the hierarchy. Then, the configuration display module 10 displays the calculated degree of depth of the hierarchy together with the multidimensional configuration.

### INCORPORATION BY REFERENCE

The disclosures of Japanese patent application No. JP2006-052728 filed on Feb. 28, 2006 including the specification, drawings and abstract are incorporated herein by reference.

What is claimed is:

1. A storage medium readable by a machine, storing a design support program, the program comprising:
a configuration displaying step of displaying a multidimensional model having a hierarchical structure configured by hierarchically combining parts on the basis of part data that define a multidimensional configuration of the part, assembly data that define a part layout or the assembly data that specify a layout of other pieces of assembly data;
a child model designating step of designating as a processing object, based on input information from a user, a child model corresponding to part of the multidimensional model containing the part data or the assembly data; and
an attribute information displaying step of displaying, by referring to the part data or assembly data corresponding to the child model designated in the child model designating step, an attribute of the child model that contains a position in a hierarchical structure thereof with respect to an image of the multidimensional model.

2. The storage medium according to claim 1, wherein the program further comprises a hierarchical degree-of-depth determining step of determining a degree of depth of the hierarchy with respect to the hierarchical structure.

3. The storage medium according to claim 2, wherein the program further comprises a hierarchical degree-of-depth displaying step of displaying the degree of depth of the hierarchy that is determined in the hierarchical degree-of-depth determining step.

4. The storage medium according to claim 1, wherein the program further comprises a model edit program for editing the part data or the assembly data in response to the input information from the user.

5. The storage medium according to claim 2, wherein the hierarchical degree-of-depth displaying step includes displaying, together with the degree of depth of the hierarchy, a child model name defined as an identification name assigned to the part data or the assembly data.

6. The storage medium according to claim 2, wherein the hierarchical degree-of-depth determining step includes determining the degree of depth of the hierarchy on the basis of pointer information that designates the child model contained in the assembly data.

7. A design support device comprising:
a configuration display module displaying a multidimensional model having a hierarchical structure configured by hierarchically combining parts on the basis of part data that define a multidimensional configuration of the part, assembly data that define a part layout or the assembly data that specify a layout of other pieces of assembly data;
a child model designation module designating as a processing object, based on input information from a user, a child model corresponding to part of the multidimensional model containing the part data or the assembly data; and
an attribute information display module displaying, by referring to the part data or assembly data corresponding to the child model designated by the child mode designation module, an attribute of the child model that contains a position in a hierarchical structure thereof with respect to an image of the multidimensional model.
